(19) United States
(12) Patent Application Publication
(10) Pub. No.: US 2009/0046361 A1
(43) Pub. Date: Feb. 19, 2009

(54) REFLECTION TYPE SCREEN AND FORWARD PROJECTION SYSTEM

(76) Inventors: Tatsuo Itoh, Osaka (JP); Kazuhisa Yamamoto, Osaka (JP); Tetsuro Mizushima, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/091,239

(22) PCT Filed: Oct. 24, 2006
(86) PCT No.: PCT/JP2006/321110

§ 371 Date: Apr. 23, 2008

(30) Foreign Application Priority Data
Oct. 24, 2005 (JP) 2005-308158

(51) Int. Cl. G03B 21/60

(52) U.S. Cl. 359/459

(57) ABSTRACT

There are provided a reflection type screen capable of suppressing effects of external light and obtaining a wide viewing angle with a simple structure, and a forward projection system having the reflection type screen.

A reflection type screen 100 has transparent prismatic members 5 arranged parallel to a longitudinal direction of a base 1, between the base 1 of a light absorbing member and a front sheet 2 of a transparent projective layer. Each transparent prismatic member 5 has a transmissive plane 3, and a diffusion-reflection plane 4 formed at a specified angle. The diffusion-reflection plane 4 is formed by arranging a reflection film on one of surfaces of the transparent prismatic member 5. Projection light is diffused and reflected by the diffusion-reflection plane 4, and external light passes through the transmissive plane 3, and is absorbed in the base 1.

### TECHNICAL FIELD

The invention relates to a reflection type screen for diffusing and reflecting protection light from a projector and displaying the protection light to an observer, and a forward projection system using the reflection type screen.

### BACKGROUND ART

In a reflection type screen for reflecting projection light from a projector, it is required to suppress drop of contrast by external light. A patent document 1 discloses a reflection type screen capable of suppressing reflection by external light other than projection light from the projector. As shown in FIG. 10, the reflection type screen in the patent document 1 includes a light permeable base unit 101, and a reflection unit 102 provided at the back side of the base unit 101. A mat shape for diffusing the projection light is formed on a surface 105 of the base unit 101. The reflection unit 102 has a reflection plane 104 of circular Fresnel lens shape. The projection light from a projector 106 passes through the base unit 101, and is diffused and reflected to the observer side by the reflection plane 104. External light entering from above the reflection type screen passes through the base unit 101, and is reflected by the reflection plane 104, and is totally reflected by the surface 105 of the base unit 101. The base unit 101 is colored for absorbing the external light, and the external light is reflected repeatedly between the reflection plane 104 and the surface 105 of the base unit 101, and is absorbed in the colored base unit 101.

Patent document 1: JP 3655972

### DISCLOSURE OF INVENTION

### Problems to be Solved by the Invention

In the conventional reflection type screen, the range of incident angle of external light that can be absorbed by the base unit 101 was limited by the condition for repeating multiplex reflection of external light between the reflection unit 102 and the surface 105 of the base unit 101. Accordingly, in the conventional reflection type screen, only the external light entering from an angle in a specified range could be absorbed sufficiently.

Not limited to a specific position, in order to reflect the projection light into a wide range, it is preferred to diffuse the projection light more widely by roughening the surface 105 of the base unit 101 and enhancing the diffusion property of the mat shape, but when the diffusion property of mat shape on the surface 105 is enhanced, the reflection capacity on the surface 105 is lowered. In the conventional reflection type screen, it is required to reflect external light totally on the surface 105 of the base unit 101, and the diffusion property of the mat shape formed on the surface 105 of the base unit 101 could not be enhanced. Accordingly, to diffuse the projection light, it was required to arrange a lenticular lens 103 for enhancing diffuseness in horizontal direction at the surface side of the base unit 101. As a result, the conventional reflection type screen is complicated in structure.

The invention is devised to solve the problems of the prior art, and it is hence an object thereof to present a reflection type screen and a forward projection system, with simple structures, capable of suppressing effects of external light in a wider range and obtaining a favorable view angle.

### Means for Solving the Problems

A reflection type screen of the invention includes a light absorbing member that absorbs light, and a plurality of diffusion-reflection members each of which has a diffusion-reflection plane formed at a specific angle on a light incident side of the light absorbing member, in which projection light is reflected by the diffusion-reflection plane, and external light is absorbed by the light absorbing member. According to this invention, decline of contrast by undesired external light other than projection light can be prevented.

Each of diffusion-reflection members may be a transparent prismatic members arranged parallel to a longitudinal direction of the light absorbing member, and the diffusion-reflection plane may be formed by arranging a reflection film on one of surfaces of the transparent prismatic member. The reflection type screen may further include a transparent protective layer that covers the plurality of diffusion-reflection members. A reflection type diffraction grating may be arranged on the diffusion-reflection plane. The reflection type diffraction grating may diffract projection light in the horizontal direction. The reflection type diffraction grating is a diffraction grating 7 of the embodiment coated with a reflection film 6 by application or vapor deposition.

The reflection type screen further may include a transparent protective layer arranged parallel to the light absorbing member, and each diffusion-reflection member may be a diffusion-reflection film which is arranged between the light absorbing member and the transparent protective layer so that an angle of the diffusion-reflection plane may be variable, and is fixed to at least one of the light absorbing member and the transparent protective layer. Space between the transparent protective layer and the light absorbing member may be made airtight, and the reflection type screen may further include an air pressure regulator that varies volume in the space.

The reflection type screen may be designed to vibrate the diffusion-reflection plane. A surface of the light absorbing member may be corrugated.

A forward projection system of the invention includes the reflection type screen, and a light source that emits projection light to the reflection type screen, in which the light source is arranged below a diffusion-reflection plane of the center of the reflection type screen. The projection light may be a laser light beam. The forward projection system may have a plurality of projectors using a laser as the light source, which are arranged in the horizontal direction.

### EFFECTS OF THE INVENTION

The reflection type screen and forward projection system of the invention are capable of suppressing effects of external light in a wider range and obtaining a favorable view angle, with simple structures.

### BRIEF DESCRIPTION OF DRAWINGS

FIG. 1 is a configuration diagram of a reflection type screen in embodiment 1 of the invention.

FIG. 2 is a sectional view of the reflection type screen in embodiment 1 of the invention.

FIG. 3 is a diagram showing other structure of base 1 in embodiment 1 of the invention.

FIG. 4A is a plan view of a transmissive plane and a diffusion-reflection plane of a reflection type screen in embodiment 2 of the invention, and FIG. 4B is a sectional view of FIG. 4A.

FIG. 5 is a configuration diagram of a reflection type screen in embodiment 3 of the invention.

FIG. 6 is a sectional view of the reflection type screen in embodiment 3 of the invention.

FIG. 7 is a layout diagram of a forward projection system in embodiment 4 of the invention.

FIG. 8 is a diagram showing a diffracted light intensity distribution of a reflection type screen when using laser light from one projector in embodiment 4 of the invention.

FIG. 9 is a diagram showing a distribution of diffracted light of the reflection type screen when using laser light from a plurality of projectors in embodiment 4 of the invention.

FIG. 10 is a configuration diagram of forward projection system in a prior art.

### DESCRIPTION OF THE REFERENCE NUMERALS

1 Base
2 Front sheet
3 Transmissive plane
4 Diffusion-reflection plane
5 Transparent prismatic member
6 Reflection film
7 Diffraction grating
8 Diffusion-reflection film
9a, 9b Fixing part
10 Air pump
71, 71a, 71b Projector
100 Reflection type screen
101 Base
102 Reflection unit
103 Lenticular lens
104 Reflection plane
105 Surface
106 Projector

### BEST MODE FOR CARRYING OUT THE INVENTION

Exemplary embodiments of the invention are described below with reference to the accompanying drawings.

### Embodiment 1

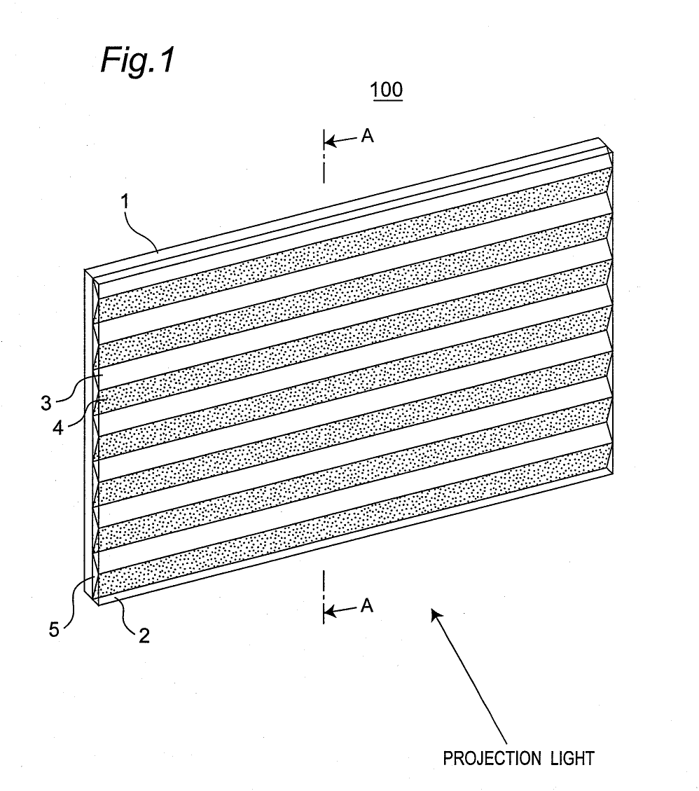

FIG. 1 shows a configuration of a reflection type screen 100 in embodiment 1 of the invention. The reflection type screen 100 of this embodiment includes a base 1 of a light absorbing member made of PET resin mixed with dye or pigment, a plurality of transparent prismatic members 5 of acrylic resin or the like arranged at the surface side of the base 1, and a front sheet 2 of transparent protective layer arranged at the surface side of the plurality of transparent prismatic members 5. The plurality of transparent prismatic members 5 are arranged parallel to the longitudinal direction of the base 1. A transparent adhesive (not shown) is filled between the base 1 and the transparent prismatic members 5 and between the transparent prismatic members 5 and the front sheet 2. Projection light from a projector enters the reflection type screen 100 through the front sheet 2.

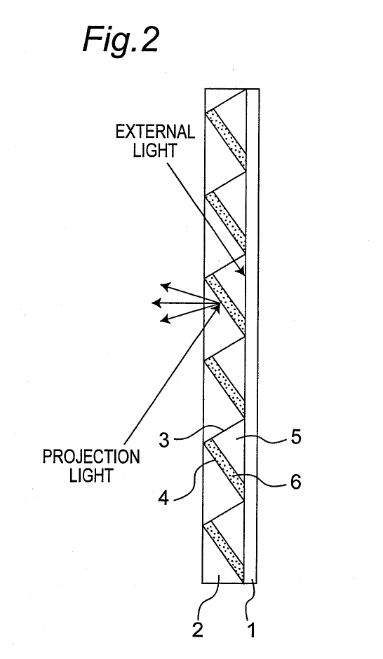

FIG. 2 is a sectional view along line A-A of the reflection type screen 100 shown in FIG. 1. Each transparent prismatic member 5 has a transmissive plane 3 and a diffusion-reflection plane 4 on its surfaces. The diffusion-reflection plane 4 is formed by forming a mat shape for enhancing the diffuseness of projection light on the transparent prismatic member 5 and coating with a reflection film 6 by application or vapor deposition.

The projection light emitted to the diffusion-reflection plane 4 from the lower side is diffused and reflected forward by the diffusion-reflection plane 4, and is observed. On the other hand, external light from ceiling lamp or the like enters from the upper side, passes through the transmissive plane 3, and is absorbed in the base 1. By suppressing external light reflection, the reflection type screen 100 of high contrast is realized in a bright room.

The reflection type screen 100 of this embodiment has a structure in which external light passes through the transmissive plane 3 and is absorbed in the base 1. Since the external light is not reflected in multiplex, the incident angle of external light is not limited. Accordingly, it is possible to absorb external light entering at an incident angle of wider range than that in the prior art.

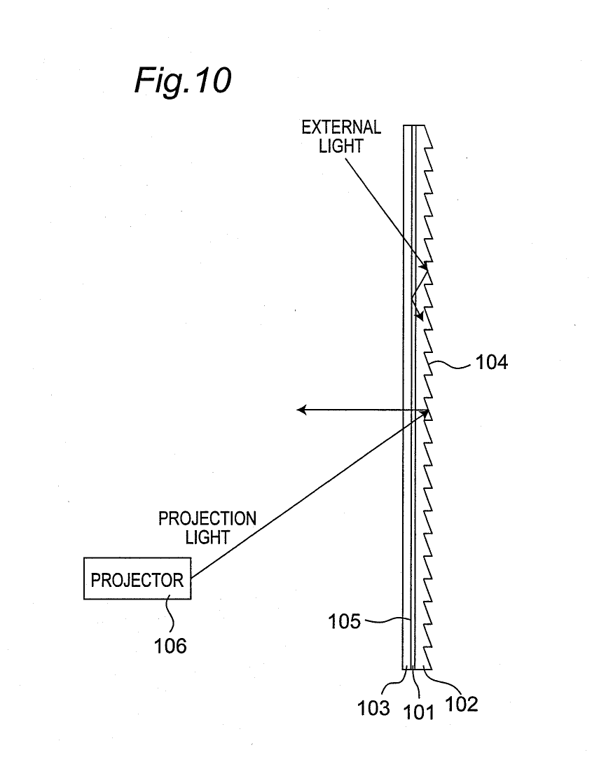

In the conventional reflection type screen, as shown in FIG. 10, both the projection light emitted from the lower side and the external light entering from the upper side pass through the base unit 101, and enter the same reflection plane 104, and are reflected. On the other hand, since the reflection type screen 100 of the embodiment has both the transmissive plane 3 and the diffusion-reflection plane 4 at the light incident side of the base 1, projection light is reflected by the diffusion-reflection plane 4, and external light enters the transmissive plane 3 and is absorbed in the base 1. In the embodiment, since the passing route of projection light is different from that of external light, only one of surfaces of each transparent prismatic member 5 can be formed as the diffusion-reflection plane 4 of mat shape. As a result, in order to assure a wider view angle, the diffuseness of mat shape can be enhanced, and projection light can be diffused sufficiently without using the conventional lenticular lens 103.

The shapes of the transmissive plane 3 and the diffusion-reflection plane 4 are not limited to the example of the embodiment. The transmissive plane 3 and the diffusion-reflection plane 4 may be made freely by forming the transparent prismatic member 5 in a desired shape so that external light may enter the base 1 through the transmissive plane 3 and projection light may be reflected by the diffusion-reflection plane 4.

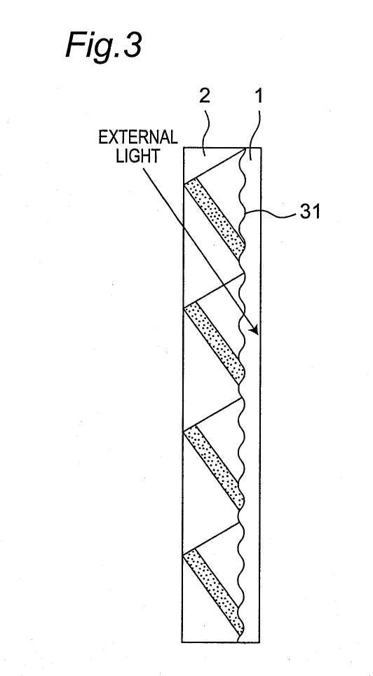

As shown in FIG. 3, the surface of the base 1 may be formed of a corrugated shape 31. As a result, the surface area of the base 1 is increased, and external light can be absorbed more efficiently. Further, the surface of the base 1 may be roughened. By roughening the surface, the surface area is increased, and external light can be absorbed more efficiently.

### Embodiment 2

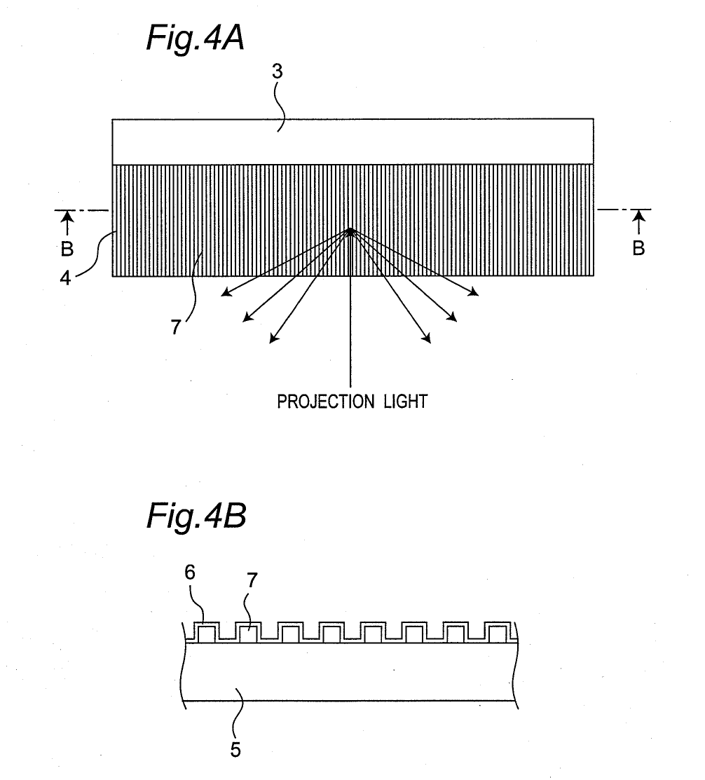

In this embodiment, other structure of the transparent prismatic member 5 is described. FIG. 4A is a plan view of the transparent prismatic member 5 in embodiment 2 of the invention. FIG. 4B is a sectional view along line B-B of the transparent prismatic member 5. In FIG. 4B, the reflection film 6 is applied or evaporated on a diffraction grating 7 in FIG. 4A. In this embodiment, the diffraction grating 7 is formed on the diffusion-reflection plane 4. The diffraction grating 7 is formed to have a periodicity in the longitudinal direction of the diffusion-reflection plane 4, and its period is from 0.5 μm to 10 μm. The diffraction grating 7 is formed, for example, by interference exposure using laser. The diffusion-reflection plane 4 of the embodiment can diffuse and reflect projection light by the diffusion-reflection plane 4, can spread the projection light in horizontal direction by the diffraction grating 7, and hence can expand the view angle in horizontal direction. Except that the diffraction grating 7 is formed on the diffusion-reflection plane 4, the configuration of the reflection type screen of this embodiment is same as that of the reflection type screen 100 in embodiment 1.

### Embodiment 3

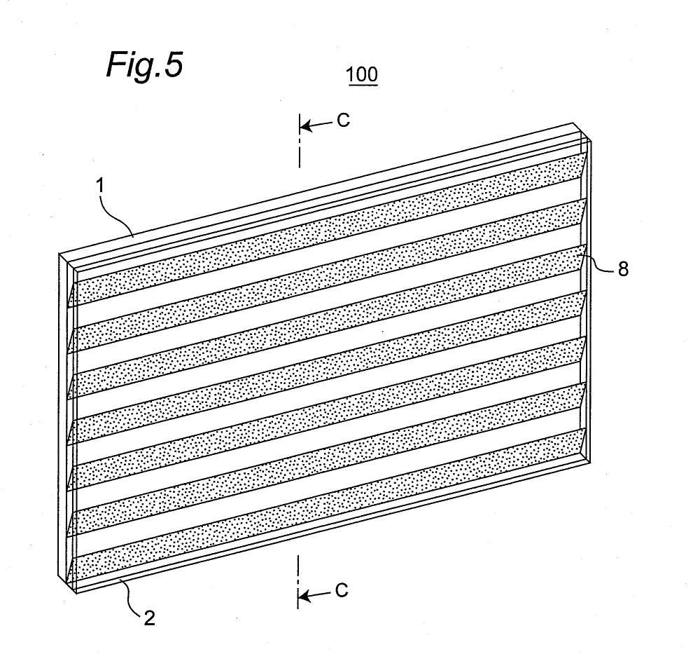

FIG. 5 shows a reflection type screen 100 in embodiment 3 of the invention. The reflection type screen 100 of the embodiment has a plurality of diffusion-reflection films 8 for diffusing and reflecting projection light from a projector, between the base 1 and the front sheet 2. The plurality of diffusion-reflection films 8 are arranged parallel to the longitudinal direction of the base 1.

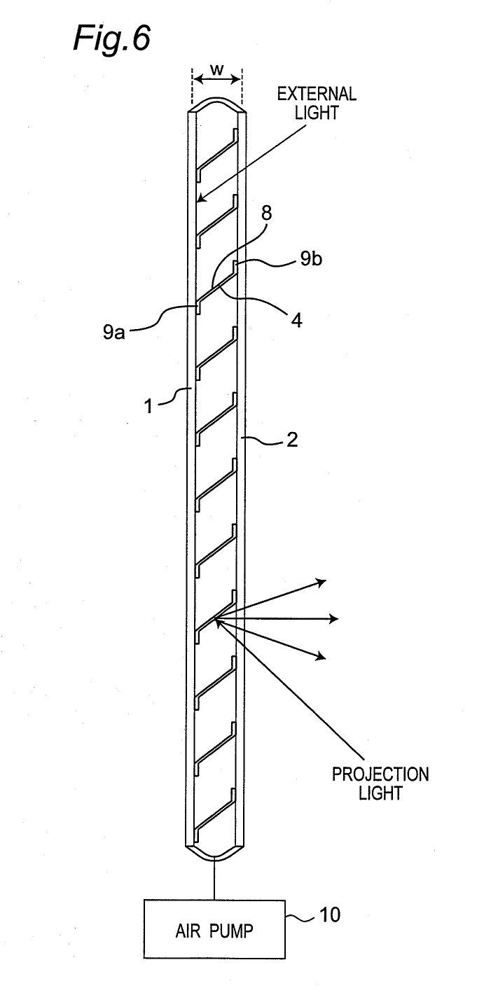

FIG. 6 is a sectional view along line C-C of the reflection type screen 100 shown in FIG. 5. Each diffusion-reflection film 8 has a diffusion-reflection plane 4 for diffusing and reflecting projection light, same as in embodiment 1 or embodiment 2. Each diffusion-reflection film 8 is provided with fixing parts 9a and 9b at both ends, and is fixed to the base 1 and the front sheet 2 by means of the fixing parts 9a and 9b. The base 1 and the front sheet 2 are made airtight with air contained inside. The reflection type screen 100 of the embodiment also has an air pump 10. The air pump 10 regulates the air pressure in the space between the base 1 and the front sheet 2, varies the volume of the space, and thereby changes the interval W of the base 1 and the front sheet 2. As a result, the tilting angle of the diffusion-reflection planes 4 of diffusion-reflection films 8 is adjusted.

According to this embodiment, depending on the incident angle of external light to the reflection type screen 100 and the emitting angle of projection light from the projector, the tilting angle of the diffusion-reflection planes 4 of diffusion-reflection films 8 can be adjusted. By adjusting the tilting angle of the diffusion-reflection planes 4, reflection quantity of external light can be adjusted. Hence, by adjusting the tilting angle of the diffusion-reflection planes 4 depending on room lighting layout, external light reflection can be reduced, and an optimum image display of high contrast is obtained.

In the embodiment, the base 1 may be movable, the front sheet 2 may be movable, or both the base 1 and the front sheet 2 may be movable.

Adjustment to angle of the diffusion-reflection planes 4 of diffusion-reflection films 8 is not limited to adjustment of air pressure by the air pump 10 of the embodiment. For example, either the base 1 or the front sheet 2 may be moved by a motor, or the interval W between the base 1 and the front sheet 2 may be changed by an electrostatic force.

In the embodiment, the both ends of each diffusion-reflection film 8 are fixed, but only one end of each diffusion-reflection film 8 may be fixed. In this case, by applying an electrostatic force on a plane opposed to a plane on which one end of the diffusion-reflection film 8 is fixed, the tilting angle of diffusion-reflection planes 4 of diffusion-reflection films 8 may be adjusted.

### Embodiment 4

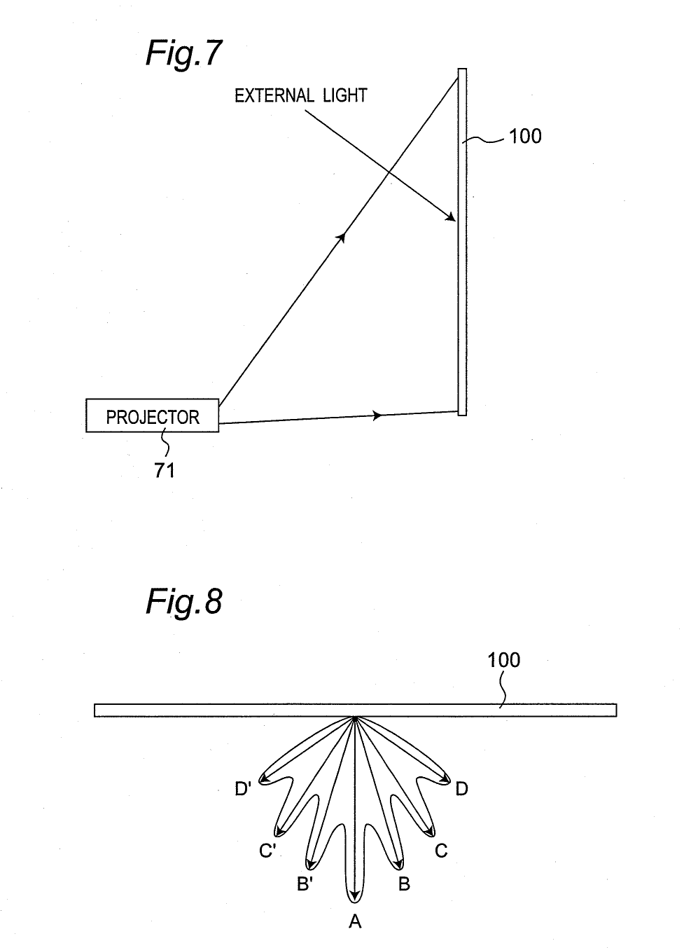

FIG. 7 shows a configuration of a forward projection system of this embodiment. The forward projection system includes the reflection type screen 100 of embodiment 2, and a projector 71. The projector 71 is arranged so that projection light may be emitted to the diffusion-reflection plane 4 of the projection type screen 100 from the lower side than the center of the projection type screen 100.

According to this embodiment, external light entering from the upper side is absorbed by the reflection type screen 100, and projection light emitted from the lower side is diffused and reflected by the diffusion-reflection plane of the reflection type screen 100. As a result, external light reflection is suppressed, and a forward projection system is realized with high contrast even in a bright room.

The projector 71 of the embodiment uses a laser light source, and emits a laser light beam as projection light. FIG. 8 shows an intensity distribution of diffracted light from the reflection type screen 100 when using a laser light. At observation points A, B, C, D, B′, C′, and D′ in FIG. 8, the projected image can be observed, but cannot be observed at other points. Intervals of A, B, C, D, B′, C′, and D′ in FIG. 7 can be varied by controlling the pitch of the diffraction grating 7 in FIG. 4. The intensity of diffracted light becomes higher at every diffraction angle depending on the degree of diffraction of the diffraction grating 7. Since the diffraction angle by the diffraction grating 7 formed on the diffusion-reflection plane 4 of the reflection type screen 100 is discrete, by superimposing the diffraction grating 7 changed in the period, the intensity distribution of diffracted light in horizontal direction can be controlled, so that the horizontal view angle can be changed discretely.

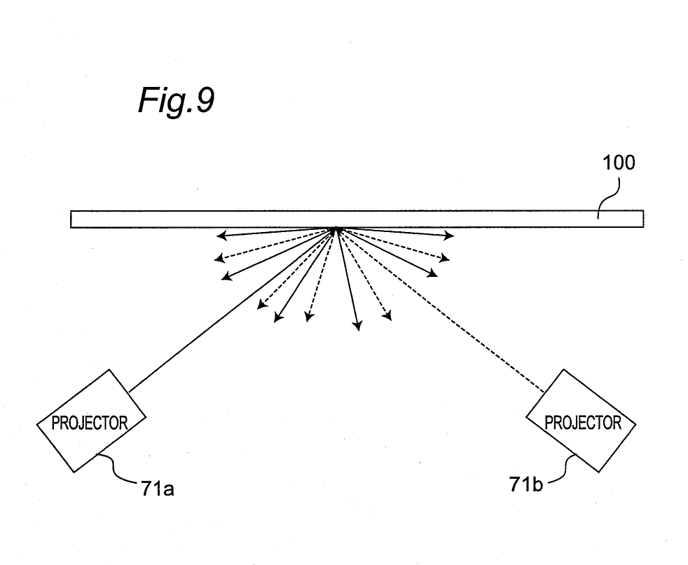

Further, as shown in FIG. 9, a plurality of projectors may be arranged horizontally so that each diffracted light may not overlap each other. In FIG. 9, the diffracted light by the projector 71a can be observed at observation point indicated by solid lines. The diffracted light by the projector 71b can be observed at observation point indicated by broken lines. Thus, by arranging a plurality of projectors in horizontal direction so that each diffracted light may not overlap each other, different images can be observed at different observation points.

The forward projection system of this embodiment includes the reflection type screen 100 of embodiment 2, but the reflection type screen 100 of embodiment 1 or embodiment 3 may be also used. In the reflection type screen 100 of embodiment 1 or embodiment 3, too, by arranging a diffraction grating on the diffusion-reflection plane 4, the horizontal view angle can be changed discretely as shown in FIG. 8 and FIG. 9.

In embodiment 1 to embodiment 4, the diffusion-reflection plane 4 may be vibrated. By vibrating the diffusion-reflection plane 4, speckle noise by laser light beams can be decreased. For example, by vibrating the reflection type screen 100 in up and down, right and left, or back and fourth direction, the diffusion-reflection plane 4 may be vibrated. Or in the configuration in FIG. 6, by varying the interval W between the base 1 and the front sheet 2 by the air pump 10, the diffusion-reflection plane 4 may be vibrated.

### INDUSTRIAL APPLICABILITY

The reflection type screen of the invention is capable of suppressing reflection of external light and widening the view angle, with simple structure, and is very useful in a forward projection system used in a bright room.

1. A reflection type screen comprising:
a light absorbing member that absorbs light; and
a plurality of diffusion-reflection members each of which has a diffusion-reflection plane formed at a specific angle on a light incident side of the light absorbing member,
wherein projection light is reflected by the diffusion-reflection plane, and external light is absorbed by the light absorbing member.

2. The reflection type screen according to claim 1, wherein each diffusion-reflection member is a transparent prismatic member arranged parallel to a longitudinal direction of the light absorbing member, and
the diffusion-reflection plane is formed by arranging a reflection film on one of surfaces of the transparent prismatic member.

3. The reflection type screen according to claim 1, further comprising a transparent protective layer that covers the plurality of diffusion-reflection members.

4. The reflection type screen according to claim 1, wherein a reflection type diffraction grating is arranged on the diffusion-reflection plane.

5. The reflection type screen according to claim 4, wherein the reflection type diffraction grating diffracts projection light in horizontal direction.

6. The reflection type screen according to claim 1, further comprising a transparent protective layer arranged parallel to the light absorbing member,
wherein each diffusion-reflection member is a diffusion-reflection film which is arranged between the light absorbing member and the transparent protective layer so that an angle of the diffusion-reflection plane may be variable, and is fixed to at least one of the light absorbing member and the transparent protective layer.

7. The reflection type screen according to claim 6, wherein space between the transparent protective layer and the light absorbing member is made airtight, and
the reflection type screen further comprises an air pressure regulator that varies volume in the space.

8. The reflection type screen according to claim 1, wherein the diffusion-reflection plane is vibrated.

9. The reflection type screen according to claim 1, wherein a surface of the light absorbing member is corrugated.

10. A forward projection system comprising:
a reflection type screen according to claim 1; and
a light source that emits projection light to the reflection type screen,
wherein the light source is arranged below a diffusion-reflection plane of the center of the reflection type screen.

11. The forward projection system according to claim 10, wherein the projection light is a laser light beam.

12. The forward projection system according to claim 10, comprising a plurality of projectors using a laser as the light source, which are arranged in the horizontal direction.
